(19) United States
(12) Patent Application Publication
(10) Pub. No.: US 2026/0067393 A1
(43) Pub. Date: Mar. 5, 2026

(54) UNINTERRUPTIBLE POWER SYSTEM AND iOS AND ANDROID MOBILE DEVICES USED WITH IT

(71) Applicant: CYBER POWER SYSTEMS, INC., TAPEI CITY (TW)

(72) Inventors: YUNG-HSIANG LIN, TAIPEI CITY (TW); HAO-CHUNG CHENG, TAIPEI CITY (TW); YUNG-YU CHU, TAIPEI CITY (TW)

(21) Appl. No.: 18/937,955

(22) Filed: Nov. 5, 2024

(30) Foreign Application Priority Data
Sep. 4, 2024 (CN) 2024112321454

(51) Int. Cl. H04M 1/72412; H04W 8/18; H04W 52/02

(52) U.S. Cl. CPC H04M 1/72412; H04W 8/183; H04W 52/0264

(57) ABSTRACT

An uninterruptible power system (UPS) and iOS and Android mobile devices used with it are provided. The UPS comprises a sensing circuit, a memory space, a control unit and a first Bluetooth module. The memory space is used to store a status information of the UPS. The control unit is used to determine whether an event occurs in the UPS based on a sensing information provided by the sensing circuit. When it is determined to be yes, the control unit updates the status information in the memory space. The first Bluetooth module is used to store a subscription setting of a mobile device, and to check whether the status information in the memory space is updated according to the subscription setting. Whenever the status information is updated, the first Bluetooth module actively transmits the updated status information to a second Bluetooth module of the mobile device.

### BACKGROUND OF THE INVENTION

### Field of the Invention

The present invention relates to the technical field of power supply, and in particular, to an uninterruptible power system (UPS), and an iOS mobile device and an Android mobile device used with it.

### Description of Related Art

An uninterruptible power system (UPS) is used to provide backup power to required equipment (such as computers, servers or medical equipment) when the AC mains fails, so that the equipment can still operate normally under such condition.

For now, the UPS has developed the function of using computers for remote monitoring. However, users of such UPS often can only sit in front of the computer for monitoring information on the screen. As a result, they cannot grasp the status of the UPS as soon as they leave their seats.

### SUMMARY OF THE INVENTION

An object of the present invention is to provide a UPS. This UPS updates its recorded status information when an event occurs, and actively transmits the updated status information via Bluetooth to a mobile device it is paired with, so that a user in the same indoor space can monitor the status of the UPS anytime and anywhere.

Another object of the present invention is to provide an iOS mobile device used with the aforementioned UPS.

Still another object of the present invention is to provide an Android mobile device used with the aforementioned UPS.

In order to achieve the above object, the present invention provides a UPS, which comprises a first switch unit, a second switch unit, a charging circuit, a DC-AC conversion circuit, a sensing circuit, a memory space, a control unit and a first Bluetooth module. The first switch unit is electrically coupled to an AC power source and one terminal of a bypass path. The second switch unit is electrically coupled to an output terminal of the UPS and the other terminal of the bypass path. The charging circuit is electrically coupled to the AC power source and a battery. The DC-AC conversion circuit is electrically coupled between the battery and the second switch unit. The sensing circuit is used to obtain a sensing information. The memory space is used to store a status information of the UPS. The control unit is electrically coupled to the first switch unit, the second switch unit, the charging circuit, the DC-AC conversion circuit and the sensing circuit to control their operations. The control unit is also used to determine whether an event occurs in the UPS based on the sensing information, and to update the status information in the memory space when it is determined to be yes. The first Bluetooth module is used to store a subscription setting of a mobile device, and to check whether the status information in the memory space is updated according to the subscription setting. Whenever the status information is updated, the first Bluetooth module actively transmits the updated status information to a second Bluetooth module of the mobile device.

In order to achieve the above another object, the present invention provides an iOS mobile device for use with the aforementioned UPS. The iOS mobile device comprises a processor and a first Bluetooth module. The processor is used for executing an iOS and for executing a UPS application through the iOS, wherein the iOS saves a subscription setting of the iOS mobile device. The first Bluetooth module is electrically coupled to the processor. The first Bluetooth module is used to connect with a second Bluetooth module of the UPS, and is used to provide the subscription setting to the second Bluetooth module. The subscription setting is followed by the second Bluetooth module to check whether a status information of the UPS is updated. The first Bluetooth module is also used to receive the status information updated by the UPS from the second Bluetooth module, and is used to notify, after receiving the updated status information, the iOS to wake up the UPS application that has entered a background mode, so as to enable the awakened UPS application to push a status notification to a screen of the iOS mobile device.

In order to achieve the above still another object, the present invention further provides an Android mobile device for use with the aforementioned UPS. The Android mobile device comprises a processor and a first Bluetooth module. The processor is used for executing an Android operating system and for executing a UPS application through the Android operating system. The UPS application has a foreground service daemon. The foreground service daemon is resident in the Android operating system and saves a subscription setting of the Android mobile device. The first Bluetooth module is electrically coupled to the processor. The first Bluetooth module is used to connect with a second Bluetooth module of the UPS, and is used to provide the subscription setting to the second Bluetooth module. The subscription setting is followed by the second Bluetooth module to check whether a status information of the UPS is updated. The first Bluetooth module is also used to receive the status information updated by the UPS from the second Bluetooth module, and is used to notify, after receiving the updated status information, the foreground service daemon, so as to enable the foreground service daemon to push a status notification to a screen of the Android mobile device through the Android operating system when the UPS application is shut down or enters a background mode.

In order to make the above objects, technical features and gains after actual implementation more obvious and easy to understand, in the following, the preferred embodiments will be described with reference to the corresponding drawings and will be described in more detail.

### BRIEF DESCRIPTION OF THE DRAWINGS

Other features and advantages of the present invention will become apparent in the following detailed description of the preferred embodiments with reference to the accompanying drawings, of which:

FIG. 1 shows a UPS according to an embodiment of the present invention.

FIG. 2 shows an iOS mobile device according to an embodiment of the present invention.

FIG. 3 shows one of the operation processes of the UPS 100.

FIG. 4 shows one of the operation processes of the iOS mobile device 1100.

FIG. 5 shows an Android mobile device according to an embodiment of the present invention.

FIG. 6 shows one of the operation processes of the Android mobile device 1200.

FIG. 7 shows a UPS according to another embodiment of the present invention.

FIG. 8 shows a UPS according to yet another embodiment of the present invention.

FIG. 9 shows a UPS according to yet another embodiment of the present invention.

FIG. 10 shows a UPS according to yet another embodiment of the present invention.

### DESCRIPTION OF EMBODIMENTS

The characteristics, contents, advantages and achieved effects of the present disclosure will become more fully understood from the detailed description given herein below and the accompanying drawings which are given by way of illustration only, and thus are not limitative of the present disclosure.

As required, detailed embodiments are disclosed herein. It must be understood that the disclosed embodiments are merely exemplary of and may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

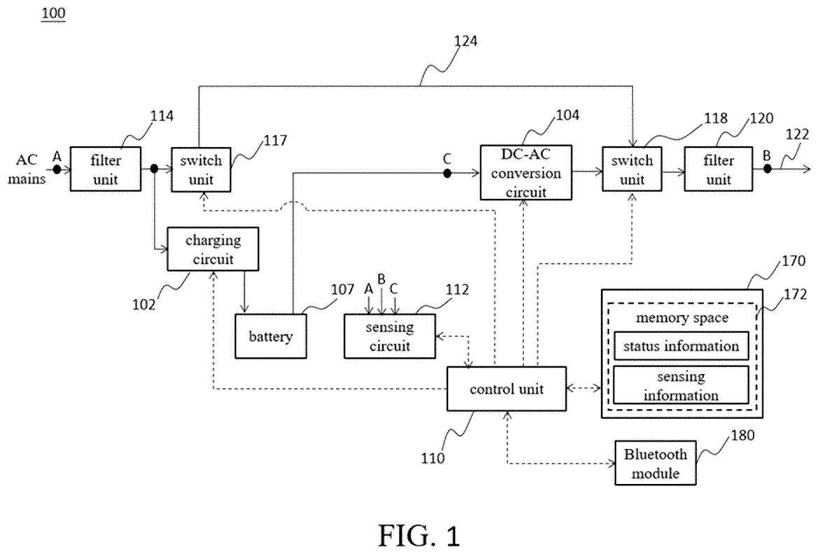

FIG. 1 shows a UPS according to an embodiment of the present invention. Please refer to FIG. 1. From the circuit structure shown in FIG. 1, it can be seen that the UPS 100 is an off-line UPS. The UPS 100 comprises a filter unit 114, a switch unit 117, a DC-AC conversion circuit 104, a switch unit 118, a filter unit 120, a bypass path 124, a charging circuit 102, a battery 107, a sensing circuit 112, a control unit 110, a memory 170 and a Bluetooth module 180. In this embodiment, the memory 170 is disposed outside the control unit 110. In addition, in this embodiment, the memory space 172 of the memory 170 is used to store a status information and a sensing information of the UPS 100 (details will be described later). The switch unit 117 is electrically coupled to one terminal of the bypass path 124, and is electrically coupled to an AC power source (e.g., AC mains) through the filter unit 114. The switch unit 118 is electrically coupled to the other terminal of the bypass path 124, and is electrically coupled to an output terminal 122 of the UPS 100 through the filter unit 120. The charging circuit 102 is electrically coupled to the battery 107, and is electrically coupled to the AC power source through the filter unit 114. The DC-AC conversion circuit 104 is electrically coupled between the battery 107 and the switch unit 118.

The control unit 110 is electrically coupled to the switch unit 117, the DC-AC conversion circuit 104, the switch unit 118, the charging circuit 102, the sensing circuit 112, the memory 170 and the Bluetooth module 180 to control their operations. For example, the control unit 110 controls the operation of the switch unit 118 to decide to electrically couple the output terminal of the DC-AC conversion circuit 104 to the filter unit 120 or to electrically couple the bypass path 124 to the filter unit 120.

The sensing circuit 112 is electrically coupled to the aforementioned AC power source, the output terminal 122 of the UPS 100 and the input terminal of the DC-AC conversion circuit 104 (shown as coupling points A, B and C, respectively) to obtain a sensing information periodically, and to transmit the obtained sensing information to the control unit 110, so that the control unit 110 can regularly update the sensing information in the memory space 172. The aforementioned sensing information comprises, for example, at least one of input voltage, input current, input frequency, output voltage, output current, output frequency, battery charge current, or battery discharge current. In addition, whenever the control unit 110 receives sensing information, it will determine whether an event occurs in the UPS 100 based on the sensing information. When the determination is yes, the control unit 110 will update the status information in the memory space 172. The aforementioned event comprises, for example, at least one of input voltage out-of-range, input current out-of-range, input frequency out-of-range, output voltage out-of-range, output current out-of-range, output frequency out-of-range, battery charge current abnormality, or battery discharge current abnormality.

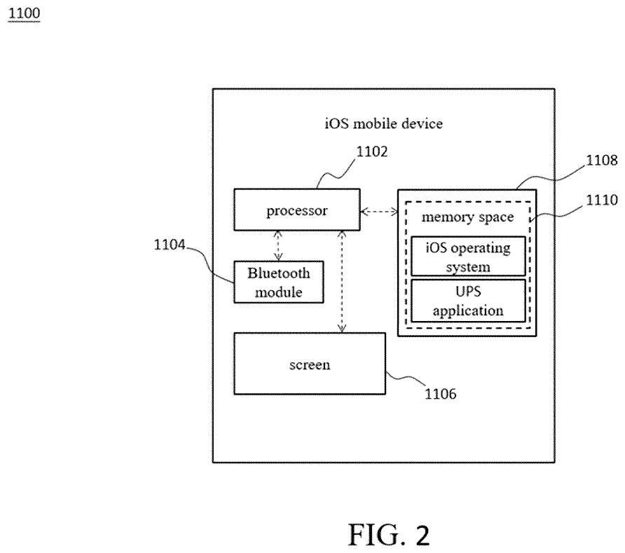

FIG. 2 shows an iOS mobile device according to an embodiment of the present invention. Please refer to FIG. 2. The iOS mobile device 1100 is configured for use with the aforementioned UPS 100. The iOS mobile device 1100 comprises a processor 1102, a Bluetooth module 1104, a screen 1106 and a memory 1108. The processor 1102 is electrically coupled to the Bluetooth module 1104, the screen 1106 and the memory 1108 to control their operations. The memory space 1110 of the memory 1108 stores an iOS (i.e., iPhone Operating System) and a UPS application (referred to as UPS APP). The processor 1102 is used for executing the iOS and for executing the UPS application through the iOS, so as to use the UPS application to monitor the UPS 100. The iOS saves a subscription setting of the iOS mobile device 1100. This subscription setting records which information in the aforementioned status information the user has subscribed to, wherein the aforementioned status information comprises information regarding input voltage out-of-range, input current out-of-range, input frequency out-of-range, output voltage out-of-range, output current out-of-range, output frequency out-of-range, battery charge current abnormality, and battery discharge current abnormality. For example, this subscription setting can record that the user has subscribed to the information regarding input current out-of-range, output current out-of-range, battery charge current abnormality and battery discharge current abnormality in the aforementioned status information.

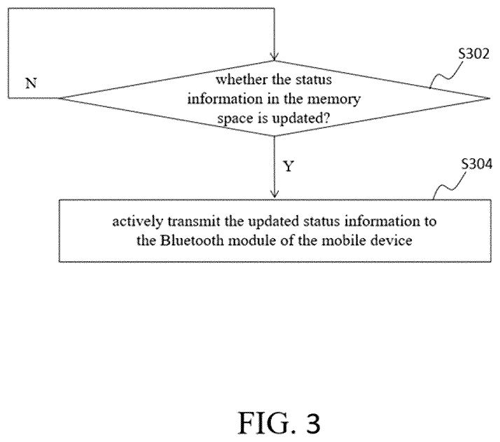

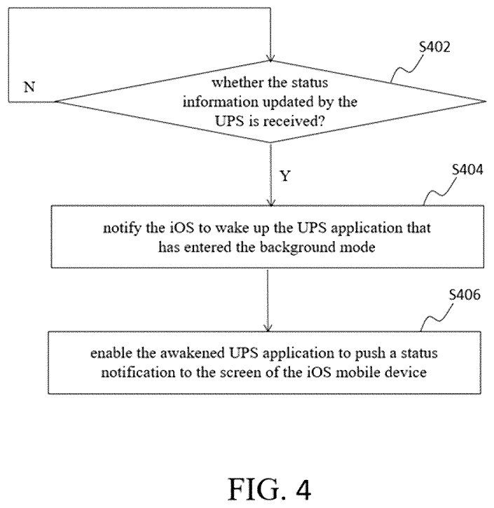

The operation of the UPS 100 and the iOS mobile device 1100 will be explained below with reference to flow charts, and it is assumed that the iOS mobile device 1100 has completed Bluetooth pairing with the UPS 100. FIG. 3 shows one of the operation processes of the UPS 100, and FIG. 4 shows one of the operation processes of the iOS mobile device 1100. Please refer to FIG. 1 to FIG. 4. The Bluetooth module 1104 of the iOS mobile device 1100 is used to connect to the Bluetooth module 180 of the UPS 100, and is used to provide the aforementioned subscription setting to the Bluetooth module 180. The Bluetooth module 180 is used to store the aforementioned subscription setting, and is used to follow the aforementioned subscription setting to check whether the status information in the memory space 172 is updated (as shown in step S302). Assuming that the subscription setting records that the user subscribes to the information regarding input current out-of-range, output current out-of-range, battery charge current abnormality and battery discharge current abnormality in the status information, then the Bluetooth module 180 will follow such a subscription content to check whether the information regarding input current out-of-range, output current out-of-range, battery charge current abnormality and battery discharge current abnormality in the status information recorded in the memory space 172 is updated.

Assuming that an event of input current out-of-range occurs in the UPS 100, then in the status information recorded in the memory space 172, the information regarding input current out-of-range will be updated. Similarly, assuming that an event of input current out-of-range and output current out-of-range occurs in the UPS 100, then in the status information recorded in the memory space 172, the information regarding input current out-of-range and the information regarding output current out-of-range will be updated. Whenever the status information in the memory space 172 is updated, the Bluetooth module 180 will actively transmit the updated status information to the Bluetooth module 1104 of the iOS mobile device 1100 (as shown in step S304). On the other hand, whenever the determination result in step S302 is no, the Bluetooth module 180 returns to step S302.

On the other hand, the Bluetooth module 1104 determines whether the status information updated by the UPS 100 from the Bluetooth module 180 is received (as shown in step S402). When the determination result in step S402 is no, the Bluetooth module 1104 returns to step S402. On the other hand, when the determination result in step S402 is yes, the Bluetooth module 1104 notifies the iOS to wake up the UPS application that has entered the background mode after receiving the updated status information (as shown in step S404), so as to enable the awakened UPS application to push a status notification to the screen 1106 of the iOS mobile device 1100 (as shown in step S406). In this way, the user can know that an event has occurred in the UPS 100 as soon as he sees this status notification. In addition, the status notification is also used for the user to click to switch the UPS application from the background mode to a foreground mode, so as to allow the user to confirm the updated status information through the UPS application. This allows the user to understand what happened in the UPS 100.

The following conditions are worth mentioning: the UPS application is restarted and enters the background mode due to the iOS mobile device 1100 being restarted; the UPS application is restarted by the iOS and enters the background mode due to prolonged inactivity; the UPS application enters the background mode due to the iOS mobile device 1100 returning to a main page; the UPS application enters the background mode due to the iOS mobile device 1100 switching to another application, or enters the background mode due to the iOS mobile device 1100 entering a standby mode. Basically, during the operation of the iOS mobile device 1100, the UPS application can be woken up by the iOS as long as the UPS application is in the background mode rather than being shut down. Certainly, if the UPS application is in the foreground mode, the UPS application can directly push the aforementioned status notification to the screen 1104 of the iOS mobile device 1100, so the iOS does not need to wake up the UPS application.

In addition, as previously mentioned, in this embodiment, the control unit 110 of the UPS 100 periodically updates the sensing information in memory space 172. Therefore, if the aforementioned subscription setting also records that the user subscribes to the sensing information, the Bluetooth module 180 will follow this subscription setting to check whether the sensing information in memory space 172 is updated. Whenever the determination is yes, the Bluetooth module 180 actively transmits the updated sensing information to the Bluetooth module 1104 of the iOS mobile device 1100. The processor 1102 of the iOS mobile device 1100 receives the sensing information of the UPS 100 periodically transmitted from the Bluetooth module 180 through the Bluetooth module 1104. Therefore, whenever the sensing information updated by the UPS 100 is not received within a preset time (such as a few seconds or minutes), the processor 1102 determines that the connection between the Bluetooth module 1104 and the Bluetooth module 180 is lost.

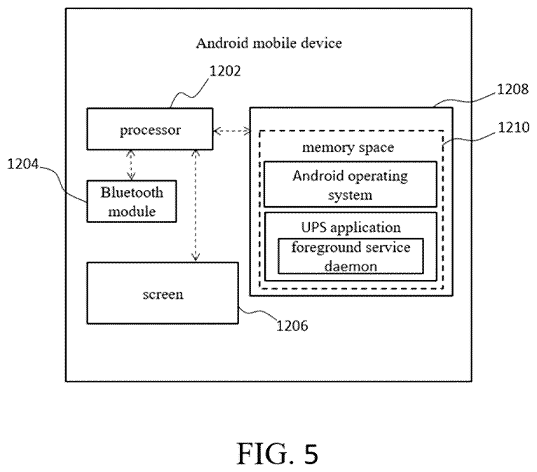

FIG. 5 shows an Android mobile device according to an embodiment of the present invention. Please refer to FIG. 5. The Android mobile device 1200 is also configured for use with the aforementioned UPS 100. The Android mobile device 1200 comprises a processor 1202, a Bluetooth module 1204, a screen 1206 and a memory 1208. The processor 1202 is electrically coupled to the Bluetooth module 1204, the screen 1206 and the memory 1208 to control their operations. The memory space 1210 of the memory 1208 stores an Android operating system and a UPS application. The processor 1202 is used for executing the Android operating system, and for executing the UPS application through the Android operating system, so as to use the UPS application to monitor the UPS 100. The UPS application has a foreground service daemon, and the foreground service daemon is resident in the Android operating system and saves a subscription setting of the Android mobile device 1200. This subscription setting records which information in the aforementioned status information the user has subscribed to, wherein the aforementioned status information comprises information regarding input voltage out-of-range, input current out-of-range, input frequency out-of-range, output voltage out-of-range, output current out-of-range, output frequency out-of-range, battery charge current abnormality, and battery discharge current abnormality. For example, this subscription setting can record that the user has subscribed to the information regarding input current out-of-range, output current out-of-range, battery charge current abnormality and battery discharge current abnormality in the aforementioned status information.

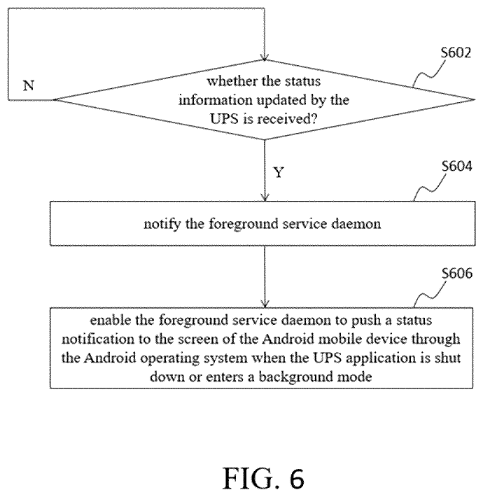

The operation of the UPS 100 and the Android mobile device 1200 will be explained below with reference to flow charts, and it is assumed that the Android mobile device 1200 has completed Bluetooth pairing with the UPS 100. FIG. 6 shows one of the operation processes of the Android mobile device 1200. Please refer to FIGS. 1, 3, 5 and 6. The Bluetooth module 1204 of the Android mobile device 1200 is used to connect to the Bluetooth module 180 of the UPS 100, and is used to provide the aforementioned subscription setting to the Bluetooth module 180. The Bluetooth module 180 is used to store the aforementioned subscription setting, and is used to follow the aforementioned subscription setting to check whether the status information in the memory space 172 is updated (as shown in step S302). Assuming that the subscription setting records that the user subscribes to the information regarding input current out-of-range, output current out-of-range, battery charge current abnormality and battery discharge current abnormality in the status information, then the Bluetooth module 180 will follow such a subscription content to check whether the information regarding input current out-of-range, output current out-of-range, battery charge current abnormality and battery discharge current abnormality in the status information recorded in the memory space 172 is updated.

Assuming that an event of input current out-of-range occurs in the UPS 100, then in the status information recorded in the memory space 172, the information regarding input current out-of-range will be updated. Similarly, assuming that an event of input current out-of-range and output current out-of-range occurs in the UPS 100, then in the status information recorded in the memory space 172, the information regarding input current out-of-range and the information regarding output current out-of-range will be updated. Whenever the status information in the memory space 172 is updated, the Bluetooth module 180 will actively transmit the updated status information to the Bluetooth module 1204 of the Android mobile device 1200 (as shown in step S304). On the other hand, whenever the determination result in step S302 is no, the Bluetooth module 180 returns to step S302.

On the other hand, the Bluetooth module 1204 determines whether the status information updated by the UPS 100 from the Bluetooth module 180 is received (as shown in step S602). When the determination result in step S602 is no, the Bluetooth module 1204 returns to step S602. On the other hand, when the determination result in step S602 is yes, the Bluetooth module 1204 notifies the foreground service daemon after receiving the updated status information (as shown in step S604), so as to enable the foreground service daemon to push a status notification to the screen 1206 of the Android mobile device 1200 through the Android operating system when the UPS application is shut down or enters the background mode (as shown in step S606). In this way, the user can know that an event has occurred in the UPS 100 as soon as he sees this status notification. In addition, this status notification is also used for the user to click, thereby causing the UPS application to enter the foreground mode and allowing the user to confirm the updated status information through the UPS application. This allows the user to understand what happened in the UPS 100.

The following conditions are worth mentioning: the UPS application is shut down because it was forced to quit while in the background mode; the UPS application is shut down due to the Android mobile device 1200 being restarted; the UPS application is shut down by the Android operating system due to prolonged inactivity. In addition, the UPS application enters the background mode due to the Android mobile device 1200 returning to a main page; the UPS application enters the background mode due to the Android mobile device 1200 switching to another application, or enters the background mode due to the Android mobile device 1200 entering a standby mode. Basically, during the operation of the Android mobile device 1200, the UPS application cannot be woken up by the Android operating system, no matter if the UPS application is shut down or is in the background mode. Therefore, it is necessary to use a foreground service daemon to coordinate with the Android operating system, so as to push a status notification to the screen 1206 of the Android mobile device 1200 through the Android operating system. Certainly, if the UPS application is in the foreground mode, the UPS application can directly push the aforementioned status notification to the screen 1204 of the Android mobile device 1200, so there is no need to use the foreground service daemon to assist with this task.

In addition, as previously mentioned, in this embodiment, the control unit 110 of the UPS 100 periodically updates the sensing information in memory space 172. Therefore, if the aforementioned subscription setting also records that the user subscribes to the sensing information, the Bluetooth module 180 will follow this subscription setting to check whether the sensing information in memory space 172 is updated. Whenever the determination is yes, the Bluetooth module 180 actively transmits the updated sensing information to the Bluetooth module 1204 of the Android mobile device 1200. The processor 1202 of the Android mobile device 1200 receives the sensing information of the UPS 100 periodically transmitted from the Bluetooth module 180 through the Bluetooth module 1204. Therefore, whenever the sensing information updated by the UPS 100 is not received within a preset time, the processor 1202 determines that the connection between the Bluetooth module 1204 and the Bluetooth module 180 is lost.

Based on the above teachings, those of ordinary skill in the art should know that the above-mentioned iOS mobile device 1100 and Android mobile device 1200 can also be used with other UPSs of different architectures. Please see the instructions below.

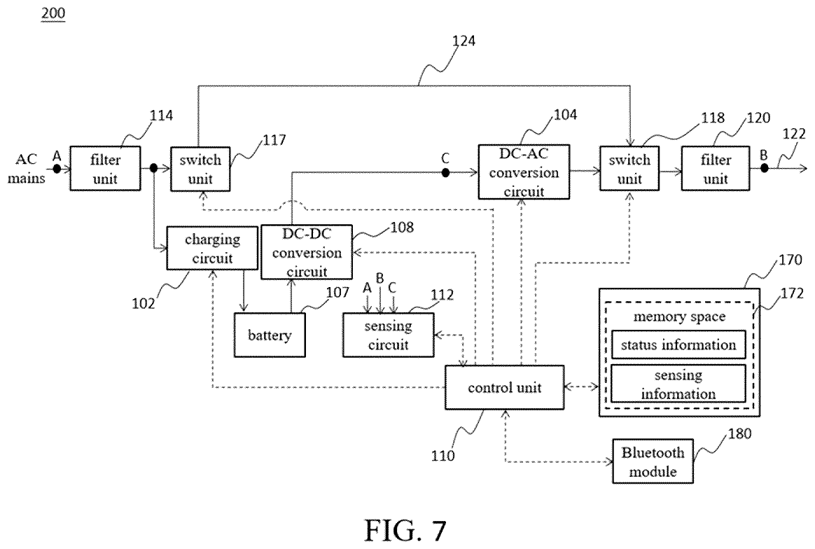

FIG. 7 shows a UPS according to another embodiment of the present invention. It can be seen from the circuit structure shown in FIG. 7 that the UPS 200 is an off-line UPS. Compared with the off-line UPS shown in FIG. 1, the off-line UPS shown in FIG. 7 further comprises a DC-DC conversion circuit 108. The DC-DC conversion circuit 108 is electrically coupled between the battery 107 and the input terminal of the DC-AC conversion circuit 104, and is electrically coupled to the control unit 110 to be controlled by the control unit 110.

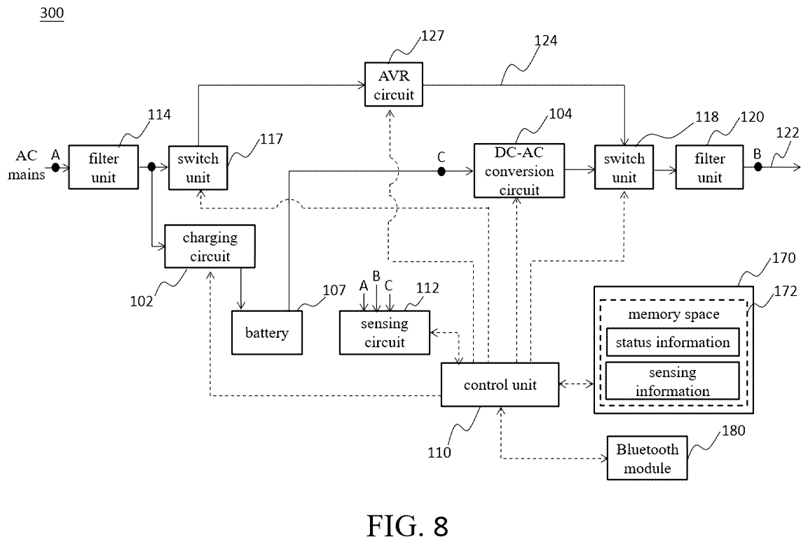

FIG. 8 shows a UPS according to yet another embodiment of the present invention. It can be seen from the circuit structure shown in FIG. 8 that the UPS 300 is a line-interactive UPS. Compared with the off-line UPS shown in FIG. 1, the line-interactive UPS shown in FIG. 8 further comprises an automatic voltage regulation circuit (AVR circuit) 127. The AVR circuit 127 is configured on the bypass path 124, and is electrically coupled to the control unit 110 to be controlled by the control unit 110.

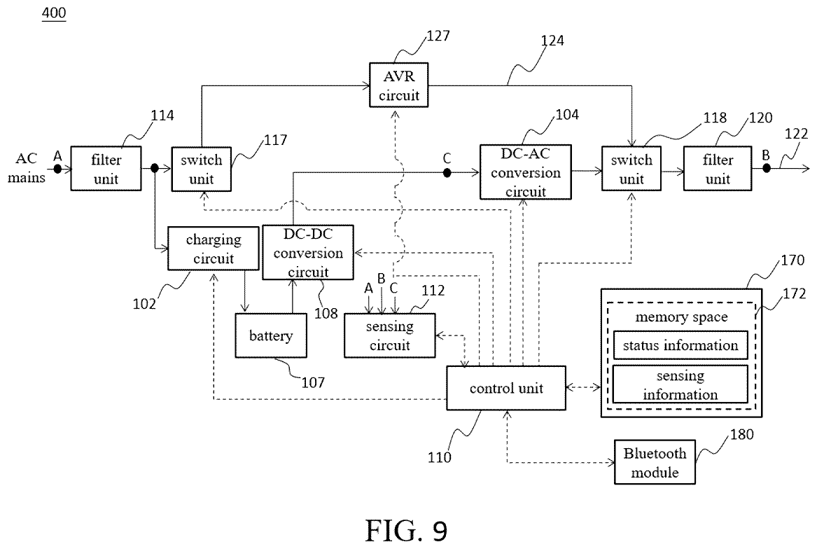

FIG. 9 shows a UPS according to yet another embodiment of the present invention. It can be seen from the circuit structure shown in FIG. 9 that the UPS 400 is a line-interactive UPS. Compared with the line-interactive UPS shown in FIG. 8, the line-interactive UPS shown in FIG. 9 further comprises a DC-DC conversion circuit 108. The DC-DC conversion circuit 108 is electrically coupled between the battery 106 and the input terminal of the DC-AC conversion circuit 104, and is electrically coupled to the control unit 110 to be controlled by the control unit 110.

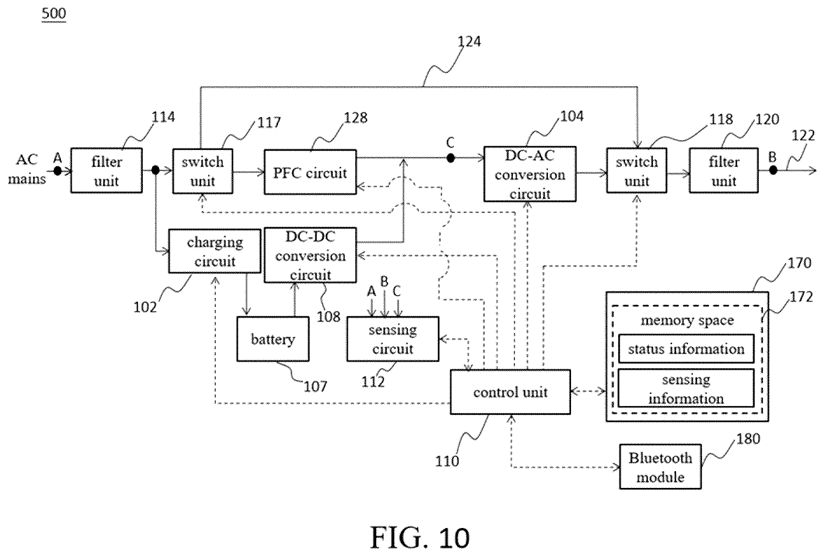

FIG. 10 shows a UPS according to yet another embodiment of the present invention. It can be seen from the circuit structure shown in FIG. 10 that the UPS 500 is an on-line UPS. Compared with the off-line UPS shown in FIG. 7, the on-line UPS shown in FIG. 10 further comprises a power factor correction circuit (PFC circuit) 128. The PFC circuit 128 is electrically coupled between the switch unit 117 and the input terminal of the DC-AC conversion circuit 104, and is electrically coupled to the control unit 110 to be controlled by the control unit 110. In addition, in this embodiment, the control unit 110 can control the operation of the switch unit 117 to decide to electrically couple the filter unit 114 to the bypass path 124 or to electrically couple the filter unit 114 to the input terminal of the PFC circuit 128.

It is worth mentioning that for each of the above-mentioned UPSs, the use of the filter units 114 and 120 can be decided according to the actual design requirements. In addition, although in the above embodiments, the sensing circuit 112 is electrically coupled to the AC power source, the output terminal 122 of the UPS 100 and the input terminal of the DC-AC conversion circuit 104, this is not intended to limit the present invention. Those of ordinary skill in the art should know that the sensing circuit 112 can be electrically coupled to at least one of the AC power source, the output terminal 122 of the UPS 100 and the input terminal of the DC-AC conversion circuit 104. If the sensing circuit 112 is electrically coupled to the AC power source, the sensing information obtained by such connection can be used to determine whether the input voltage is out of range, whether the input current is out of range, and whether the input frequency is out of range. If the sensing circuit 112 is electrically coupled to the output terminal 122 of the UPS 100, the sensing information obtained by such connection can be used to determine whether the output voltage is out of range, whether the output current is out of range, and whether the output frequency is out of range. If the sensing circuit 112 is electrically coupled to the battery 107 or the input terminal of the DC-AC conversion circuit 104, the sensing information obtained by such connection can be used to determine whether the battery charge current is abnormal and whether the battery discharge current is abnormal. Certainly, the sensing circuit 112 can also be coupled to other components to obtain other sensing information.

In addition, although in the above embodiments, the memory space 172 is located in the memory 170 outside the control unit 110, this is not intended to limit the present invention. Those of ordinary skill in the art should know that the memory space 172 may be located in an internal memory or register of the control unit 110. Similarly, the memory space 1110 does not have to be located in the memory 1108 outside the processor 1102. The memory space 1110 can also be located in the internal memory or register of the processor 1102. Similarly, the memory space 1210 does not have to be located in the memory 1208 outside the processor 1202. The memory space 1210 can also be located in an internal memory or register of the processor 1202. In addition, the aforementioned subscription setting does not have to subscribe to the sensing information in the memory space 172. Therefore, the memory space 172 does not have to store sensing information, the control unit 110 does not have to regularly update the sensing information in the memory space 172, and the Bluetooth module 180 does not have to regularly transmit the updated sensing information to the Bluetooth modules 1104 and 1204.

In summary, the UPS of the present invention updates its recorded status information when an event occurs and actively transmits the updated status information to the mobile device used with it via Bluetooth. This allows a status notification to be pushed to the screen of the mobile device (even if the UPS application for monitoring the UPS is shut down or enters background mode). As a result, a user in the same indoor space can monitor the status of the UPS anytime and anywhere.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An uninterruptible power system (UPS), comprising:
a first switch unit, electrically coupled to an AC power source and one terminal of a bypass path;
a second switch unit, electrically coupled to an output terminal of the UPS and the other terminal of the bypass path;
a charging circuit, electrically coupling the AC power source and a battery;
a DC-AC conversion circuit, electrically coupled between the battery and the second switch unit;
a sensing circuit, for obtaining a sensing information;
a memory space, used to store a status information of the UPS;
a control unit, electrically coupled to the first switch unit, the second switch unit, the charging circuit, the DC-AC conversion circuit and the sensing circuit to control their operations, the control unit being also used to determine whether an event occurs in the UPS based on the sensing information provided by the sensing circuit, and to update the status information in the memory space when it is determined to be yes; and
a first Bluetooth module, used to store a subscription setting of a mobile device, and to check whether the status information in the memory space is updated according to the subscription setting, wherein whenever the status information is updated, the first Bluetooth module actively transmits the updated status information to a second Bluetooth module of the mobile device.

2. The UPS as claimed in claim 1, wherein the memory space is further used to store the sensing information, the control unit is further used to regularly update the sensing information in the memory space, and the first Bluetooth module is further used to check whether the sensing information in the memory space is updated according to the subscription setting, whenever it is determined to be yes, the first Bluetooth module actively transmits the updated sensing information to the second Bluetooth module.

3. The UPS as claimed in claim 1, wherein the sensing circuit is at least electrically coupled to the AC power source, and the event comprises at least one of the following: input voltage out-of-range, input current out-of-range, or input frequency out-of-range.

4. The UPS as claimed in claim 1, wherein the sensing circuit is at least electrically coupled to the output terminal of the UPS, and the event comprises at least one of the following: output voltage out-of-range, output current out-of-range, or output frequency out-of-range.

5. The UPS as claimed in claim 1, wherein the sensing circuit is at least electrically coupled to the battery, and the event comprises at least one of the following: battery charge current abnormality, or battery discharge current abnormality.

6. The UPS as claimed in claim 1, further comprising a DC-DC conversion circuit, the DC-DC conversion circuit being electrically coupled between the battery and an input terminal of the DC-AC conversion circuit.

7. The UPS as claimed in claim 6, further comprising a PFC circuit, the PFC circuit being electrically coupled between the first switch unit and the input terminal of the DC-AC conversion circuit.

8. The UPS as claimed in claim 1, further comprising an AVR circuit, the AVR circuit being configured on the bypass path.

9. An iOS mobile device, for use with a UPS, the iOS mobile device comprising:
a processor, for executing an iOS and for executing a UPS application through the iOS, wherein the iOS saves a subscription setting of the iOS mobile device; and
a first Bluetooth module, electrically coupled to the processor, the first Bluetooth module being used to connect with a second Bluetooth module of the UPS, and being used to provide the subscription setting to the second Bluetooth module, the subscription setting being followed by the second Bluetooth module to check whether a status information of the UPS is updated, the first Bluetooth module being also used to receive the status information updated by the UPS from the second Bluetooth module, and being used to notify, after receiving the updated status information, the iOS to wake up the UPS application that has entered a background mode, so as to enable the awakened UPS application to push a status notification to a screen of the iOS mobile device.

10. The iOS mobile device as claimed in claim 9, wherein the UPS application is restarted and enters the background mode due to the iOS mobile device being restarted; the UPS application is restarted by the iOS and enters the background mode due to prolonged inactivity; the UPS application enters the background mode due to the iOS mobile device returning to a main page; the UPS application enters the background mode due to the iOS mobile device switching to another application, or enters the background mode due to the iOS mobile device entering a standby mode.

11. The iOS mobile device as claimed in claim 9, wherein the status notification is used for a user to click to switch the UPS application from the background mode to a foreground mode, so as to allow the user to confirm the updated status information.

12. The iOS mobile device as claimed in claim 9, wherein the processor further receives a sensing information of the UPS periodically transmitted from the second Bluetooth module through the first Bluetooth module, and the processor determines that the connection between the first Bluetooth module and the second Bluetooth module is lost whenever the sensing information is not received within a preset time.

13. An Android mobile device, for use with a UPS, the Android mobile device comprising:
a processor, for executing an Android operating system and for executing a UPS application through the Android operating system, the UPS application having a foreground service daemon, the foreground service daemon being resident in the Android operating system and saving a subscription setting of the Android mobile device; and
a first Bluetooth module, electrically coupled to the processor, the first Bluetooth module being used to connect with a second Bluetooth module of the UPS, and being used to provide the subscription setting to the second Bluetooth module, the subscription setting being followed by the second Bluetooth module to check whether a status information of the UPS is updated, the first Bluetooth module being also used to receive the status information updated by the UPS from the second Bluetooth module, and being used to notify, after receiving the updated status information, the foreground service daemon, so as to enable the foreground service daemon to push a status notification to a screen of the Android mobile device through the Android operating system when the UPS application is shut down or enters a background mode.

14. The Android mobile device as claimed in claim 13, wherein the UPS application is shut down because it was forced to quit while in the background mode; the UPS application is shut down due to the Android mobile device being restarted; the UPS application is shut down by the Android operating system due to prolonged inactivity; the UPS application enters the background mode due to the Android mobile device returning to a main page; the UPS application enters the background mode due to the Android mobile device switching to another application, or enters the background mode due to the Android mobile device entering a standby mode.

15. The Android mobile device as claimed in claim 13, wherein the status notification is used for a user to click to enable the UPS application to enter a foreground mode, so as to allow the user to confirm the updated status information.

16. The Android mobile device as claimed in claim 13, wherein the processor further receives a sensing information of the UPS periodically transmitted from the second Bluetooth module through the first Bluetooth module, and the processor determines that the connection between the first Bluetooth module and the second Bluetooth module is lost whenever the sensing information is not received within a preset time.
